(19) United States
(12) Patent Application Publication
(10) Pub. No.: US 2025/0389257 A1
(43) Pub. Date: Dec. 25, 2025

(54) HEAT EXTRACTION METHOD FOR LIQUID DOMINATED GEOTHERMAL RESERVOIRS

(71) Applicant: GreenFire Energy Inc., Oklahoma City, OK (US)

(72) Inventors: Alvaro Amaya, Oklahoma City, OK (US); Harish Chandrasekar, Oklahoma City, OK (US); Greg Szutiak, Oklahoma City, OK (US); Alan D. Eastman, Oklahoma City, OK (US)

(73) Assignee: GreenFire Energy Inc., Oklahoma City, OK (US)

(21) Appl. No.: 19/246,563

(22) Filed: Jun. 23, 2025

Related U.S. Application Data
(60) Provisional application No. 63/662,678, filed on Jun. 21, 2024.

(51) Int. Cl. F03G 4/00; E21B 33/12; F04D 13/08; F24T 10/00; F24T 10/20

(52) U.S. Cl. CPC F03G 4/035; F04D 13/08; F24T 10/20; E21B 33/12; F24T 2010/56

(57) ABSTRACT

Methods and systems for extracting geothermal energy are disclosed. The method may include inserting a closed-loop geothermal system into a wellbore penetrating a geothermal reservoir, where the closed-loop geothermal system comprises a fluid conduit, and a downhole end of the fluid conduit is disposed in a first downhole portion of the wellbore, disposing a pump with a fluid inlet positioned within the first downhole portion, and drawing, using the pump, geothermal fluid into the first downhole portion of the wellbore. The method may further include extracting heat, using the closed-loop geothermal system circulating a working fluid, from the drawn geothermal fluid within the first downhole portion and transporting the extracted heat to a primary heat utilization facility disposed on the surface of the earth.

### FIELD OF DISCLOSURE

Embodiments of the current disclosure may generally relate to the recovery of greater quantities of heat from subsurface geological formations via the drilling and completion of wellbores.

### BACKGROUND

Geothermal energy is typically recovered from geothermal reservoirs located in subterranean regions using wellbores drilled from the surface of the earth to penetrate the geothermal reservoir. Typically, cool fluid is pumped down one wellbore, its temperature rises as it absorbs heat from the hot rock of the geothermal reservoir, and the hot fluid recovered to the surface through either a second wellbore or the first wellbore. As heat is absorbed from the hot rock of the geothermal reservoir there is a tendency for the temperature of the portion of the geothermal reservoir from which heat is extracted by the geothermal system to cool, thereby reducing the efficiency (i.e., rate of heat production) of the geothermal system. As a consequence, many geothermal systems that once produced heat prolifically no longer do so at the same rate. In addition, some geothermal systems never produce the amount of heat expected, thus increasing the risk profile of geothermal development.

As a consequence, there exists a long felt need for methods to enhance the amount of heat that a geothermal system may produce steadily over long periods of time.

### SUMMARY

This summary is provided only to introduce a selection of concepts that are further described below in the detailed description. This summary is not intended to identify key or essential features of the claimed subject matter, nor is it intended to be used as an aid in limiting the scope of the claimed subject matter.

In general, in one aspect, the invention relates to a geothermal system, including a wellbore penetrating a geothermal reservoir, a closed-loop geothermal system disposed in the wellbore, having a downhole end disposed in a first downhole portion of the wellbore, where the closed-loop geothermal system comprises a fluid conduit, and the first downhole portion lies within the geothermal reservoir, a primary heat utilization facility disposed on the surface of the earth and connected to an uphole end of the fluid conduit, and a pump configured to draw geothermal fluid into the first downhole portion of the wellbore.

In general, in one aspect, the invention relates to a method for extracting geothermal energy. The method may include inserting a closed-loop geothermal system into a wellbore penetrating a geothermal reservoir, where the closed-loop geothermal system comprises a fluid conduit, and the downhole end of the fluid conduit is disposed in a first downhole portion of the wellbore, disposing a pump with a fluid inlet positioned within the first downhole portion, and drawing, using the pump, geothermal fluid into the first downhole portion of the wellbore. The method may further include extracting heat, using the closed-loop geothermal system circulating a working fluid, from the drawn geothermal fluid within the first downhole portion and transporting the extracted heat to a primary heat utilization facility disposed on the surface of the earth.

In general, in one aspect, the invention relates to a method of extracting geothermal energy. The method may include inserting a closed-loop geothermal system into a first portion of a wellbore penetrating a geothermal reservoir, extracting, by operating the closed-loop geothermal system, heat from the geothermal reservoir, where extracting heat lowers the temperature of geothermal fluid filling the first portion of the wellbore. The method may further include inserting a downhole pump into the first portion of the wellbore once the temperature of the geothermal fluid within the first portion has cooled below a maximum operating temperature of the downhole pump, and operating the downhole pump at a first rate to extract cooled geothermal fluid from the first portion and draw hot geothermal fluid into the first portion from the geothermal reservoir, and the drawn hot geothermal fluid increases the temperature of the geothermal fluid within the first portion.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1D display closed-loop geothermal systems in accordance with one or more embodiments.

FIGS. 2A-2B display geothermal systems in accordance with one or more embodiments.

FIGS. 3A-3B display a geothermal system in accordance with one or more embodiments.

FIG. 4 displays a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details or with modifications to them. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and precede or follow the second element in an ordering of elements.

It is to be understood that the singular forms “a,” “an,” and “the” include plural referents unless the context clearly dictates otherwise. Thus, for example, reference to “a downhole pump” includes reference to one or more of such downhole pumps.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

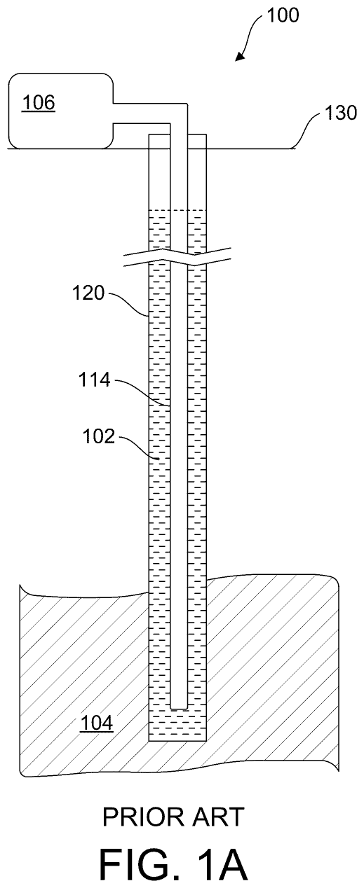

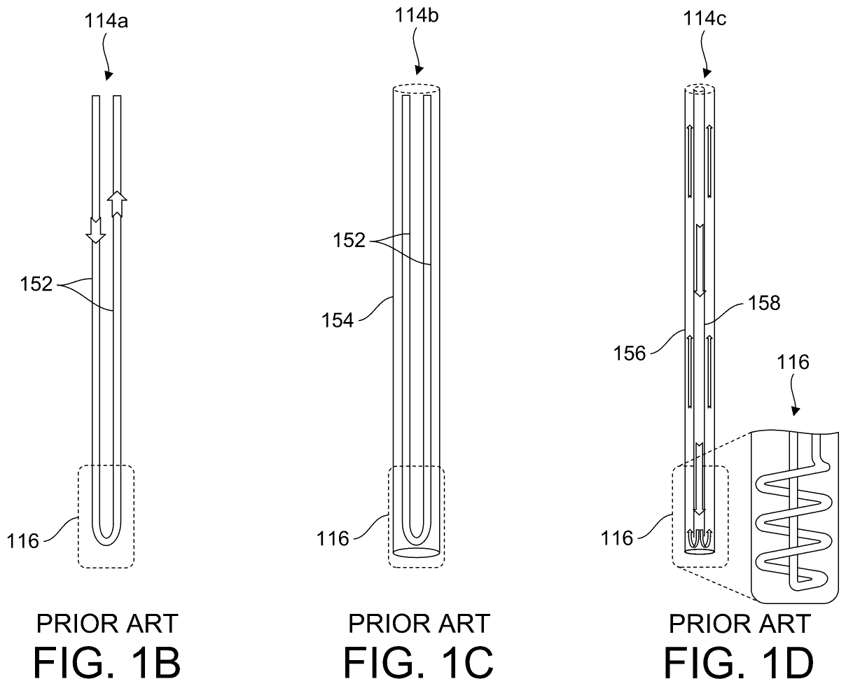

In the following description of FIGS. 1-4, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

The purpose of geothermal systems is to provide a plentiful, steady flow of heat from geothermal reservoirs located within subterranean rock formations over long periods of time, ideally for decades. The geothermal reservoir typically consists of hot rock and, in some cases, hot geothermal fluid such as brine, initially located within the pores and fractures of the geothermal reservoir rock. Typically, wellbores are drilled from the surface of the earth into a geothermal reservoir, that may be located many thousands of feet below the surface, and geothermal systems use the wellbores to extract the heat.

Particularly when single-well geothermal systems are used, the extraction of heat from the volume of the geothermal reservoir surrounding the wellbore may over time lead to a reduction in temperature of the geothermal reservoir within the volume surrounding the wellbore, unless the rate at which heat is extracted is reduced to match the rate at which heat flows into the volume surrounding the wellbore. In the absence of geothermal fluid flow though the geothermal reservoir, and/or into the wellbore, heat flow is dominated by relatively inefficient thermal conduction through the geothermal reservoir rock and pore fluids. Consequently, the goal of a plentiful, steady flow of heat over the long-term may prove challenging without further action.

Embodiments herein provide a solution to this challenge. In geothermal reservoirs that exhibit significant naturally occurring or man-made porosity, permeability, and the presence of a geothermal fluid such as brine, heat may be transferred by convective action in addition to conduction. This method is much more efficient than thermal conduction alone. Convective heat flow can be induced by pulling hot geothermal fluid from distant portions of the geothermal reservoir through the volume surrounding the wellbore, and into the wellbore itself. To achieve this heat flow, the pressure in at least a portion of the wellbore may be lowered by pumping the fluid within the wellbore to a different portion of the well or out of the wellbore to the surface. As a result, geothermal fluid flows into the wellbore carrying heat that maintains the temperature in and around the wellbore. This pumping process increases the temperature and thereby enables and sustains high levels of heat transfer to the surface.

However, the temperature of many geothermal reservoirs may exceed the temperature and pressure ratings of typical downhole pumps. Operation of pumps beyond their safe rating limits may lead to degradation of performance and/or premature failure. A primary advantage of the proposed invention is the ability to control the operation of a closed-loop geothermal system so as to cool the wellbore containing the downhole end of the closed-loop geothermal system and the downhole pump. Thus, the heat production (extraction) rate of the closed-loop geothermal system may be managed, according to embodiments herein, to ensure the wellbore does not exceed the maximum operating temperature of the downhole pump. Meanwhile, the downhole pump pulls an inflow of hot geothermal fluid from the geothermal reservoir to prevent the temperature from falling significantly below the desired operating temperature.

FIG. 1A-1D depicts the elements of conventional closed-loop geothermal systems (100) together with a method of operation. The system comprises a wellbore (102) running from the surface of the earth (130) to a geothermal reservoir (104) in the subsurface. Typically, the geothermal reservoir (104) will be one or more rock formations characterized by an elevated temperature that may lie at intervals to a depth of several thousand feet below the surface of the earth (130). In some cases, the rock formation may be a volcanic pluton, solidified from molten lava injected by volcanic or tectonic forces between the surrounding rock formations, and may have a low fluid permeability. In other cases, the geothermal reservoir (104) may include rocks with substantial porosity and permeability as a result of the natural grain-sized structure of the rock and/or as a result of anthropomorphic actions such as hydraulic fracturing and acidizing of portions of the geothermal reservoir (104) to create porosity and permeability or to enhance preexisting porosity and permeability. Typically, geothermal fluids found in the pores and fractures of a geothermal reservoir may be brine. Frequently, geothermal fluid may, in addition, contain commercially valuable minerals, such as lithium and beryllium salts.

The wellbore (102) may be substantially vertical (as shown) or may be slightly to significantly deviated. The wellbore (102) may also have horizontal portions, or even portions that become shallower with increasing distance along the wellbore. Portions of the wellbore may be cased, typically with steel pipe, to form a cased hole (120). Typically, at least the shallowest portions of the wellbore may be cased to provide mechanical stability to the wellbore and/or to isolate near-surface ground water, including drinking water aquifers from fluid originating at deeper depths and/or the drilling fluids used to create the wellbore (102). Often the casing will be cemented into place, using an annular sheath of cement between the exterior surface of the casing and the rock wall of the wellbore. In some cases, multiple sets (“strings”) of casing (not shown) may be present, disposed within one another and substantially sharing a common axis. Other portions of the wellbore (102) may be left uncased to create “open hole” portions of the wellbore (102), or be completed with a fluid-permeable tubing, such as a slotted liner, or the impermeable casing may be perforated to create holes through which geothermal fluid may flow from the geothermal reservoir into the wellbore or, vice versa, from the wellbore into the geothermal reservoir. While casing essentially isolates the interior of the cased hole (120) from the fluids in the surrounding rock formation and provides additional thermal insulation in the form of one or more layers of steel and cement, open hole portions or portions completed with fluid-permeable tubing permit fluid, including hot geothermal fluid, and heat to flow more easily into and out of the portion so completed.

The closed-loop geothermal systems shown in FIGS. 1A-1D may be inserted into a wellbore (102) drilled for the intended purpose of inserting the closed-loop geothermal system. However, in other cases a wellbore intended or previously used for another purpose may be used. For example, a wellbore previously drilled to provide fresh water, for geotechnical purposes, for open-loop geothermal purposes, or for hydrocarbon exploration may be used or extended for the closed-loop geothermal system. In other embodiments, the wellbore (102) may be drilled specifically for the construction of the closed-loop geothermal system using a wellbore drilling system.

Disposed in the wellbore (102) is a bidirectional fluid conduit (114) configured to carry a cool working fluid from a first end of the bidirectional fluid conduit (114) near the surface of the earth to a downhole end of the bidirectional fluid conduit (114) located in or near the geothermal reservoir (104), and further carry a hot working fluid back to the first end of the bidirectional fluid conduit (114).

Several forms of bidirectional fluid conduit (114) are known in the art and three designs are shown in FIG. 1B-1D for the sake of illustration. However, the design of the bidirectional fluid conduit (114) should not be interpreted as limiting the scope of the claimed invention.

At, near, or above the surface of the earth (130) the bidirectional fluid conduit (114) may connect to a primary heat utilization facility (106). The primary heat utilization facility (106) may extract heat from the hot working fluid of the closed-loop geothermal system (100) and then pump the now cool working fluid back through the bidirectional fluid conduit (114) downhole again. In some embodiments, the primary heat utilization facility (106) may include, without limitation, one or more pumping systems, one or more heat exchangers, such as an uphole heat exchanger to extract heat energy from the hot working fluid, and/or one or more turbines, such as turbine to generate electrical power, i.e., an electricity generator. In other embodiments, the uphole heat exchanger may be separate from but thermally connected to the primary heat utilization facility (106). The uphole turbine(s) may be connected to the uphole heat exchanger(s) or connected directly to the bidirectional fluid conduit (114) carrying the hot working fluid uphole.

FIG. 1B-1D depicts three examples of the bidirectional fluid conduit (114) that carries the working fluid of the closed-loop geothermal system. For example, bidirectional fluid conduit design (114a), shown in FIG. 1B, takes the form of a simple U-shaped tube, or “U-tube” (152), bent through 180 degrees at the downhole end and fluidly connected to the primary heat utilization facility at the uphole end. Cool working liquid may be pumped down one leg of the U-tube and recovered as hot working liquid up the second leg of the U-tube.

Bidirectional fluid conduit design (114b), shown in FIG. 1C, is similar to bidirectional fluid conduit design (114a) but differs in that the U-tube component is disposed with an external outer tube (154) for mechanical protection. The external outer tube may, in addition to the U-tube (152) contain a thermally conductive material, such as a thermally conductive liquid, solid, or slurry to facilitate the conduction of heat from the wellbore into the working fluid.

Bidirectional fluid conduit design (114c), shown in FIG. 1D, provides a coaxial configuration with an inner tube (158) contained within an outer tube (156). In some cases, the cool working liquid may be pumped down the inner tube (158) and, as hot working fluid, back up the annulus formed between the outer surface of the inner tube (158) and the inner surface of the outer tube (156). In many cases, due to ease of deployment, particularly in relatively small diameter wellbores, bidirectional fluid conduit design (114c) may be the preferred design.

Each of the designs for bidirectional fluid conduit (114a-c) may further be combined with a downhole heat exchanger (116) located at, or near, the downhole end of the bidirectional fluid conduit. The downhole heat exchangers (116) may facilitate the efficient transfer of heat from the fluid filling the wellbore (102), which may be geothermal fluid, to the working fluid circulating in the bidirectional fluid conduit (114) of the closed-loop geothermal system (100). The downhole heat exchanger (116) may function to heat a cool working fluid supplied to it by transferring heat from hot geothermal fluid surrounding the downhole heat exchanger (116) and producing hot working fluid. Tubulars (pipes) must fluidically connect the downhole heat exchanger (116) with the primary heat utilization facility (106) on the surface of the earth (130), and particularly with the uphole heat exchanger, allowing cool working fluid to flow, or to be pumped, for example by uphole pump, downhole, and hot working fluid to flow uphole. The tubulars must be configured to allow cool working fluid to flow in one direction and hot working fluid to flow in the opposite direction without mixing with one another.

It is worth reiterating that a closed-loop geothermal system (100), whatever its internal design, is distinguished by the fact that although heat transfers from the geothermal fluid (sometimes referred to as the “production fluid” or “produced fluid”) in which the downhole end of the closed-loop geothermal system (100) is immersed, to the working fluid enclosed and circulating within the closed-loop geothermal system (100); the geothermal fluid and the working fluid never intermix or comingle.

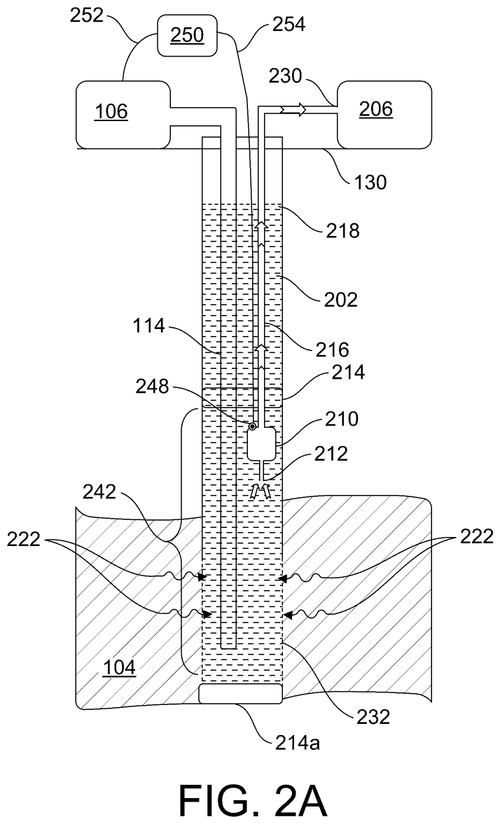

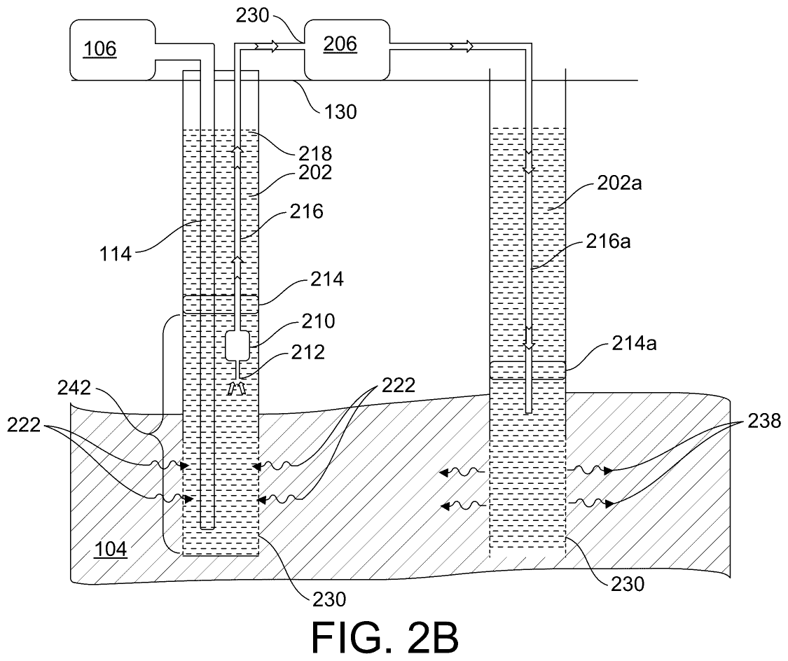

FIG. 2A illustrates a system in accordance with one or more embodiments. In addition to the closed-loop geothermal system depicted in FIGS. 1A and 1B consisting at least in part of a primary heat utilization facility (106) connected to the uphole end of a bidirectional fluid conduit (114) deployed in a wellbore (202) penetrating a geothermal reservoir (104), the system also includes a pump, such as downhole pump (210) configured to pull geothermal fluid (222) into a first downhole portion (242) of the wellbore (202). The first downhole portion (242) of the wellbore (202) may be openhole or completed with a fluid permeable tubing (232), such as a slotted liner or perforated casing, to permit geothermal fluid to be pulled into the first downhole portion from the geothermal reservoir (104). The wellbore may be wholly or partially filled with fluid up to a surface level (218) that may lie at the surface of the earth or at a lower level.

In accordance with one or more embodiments, a downhole temperature sensor (248) may be deployed in the geothermal fluid filling the wellbore (202) surrounding the downhole pump (210). In some embodiments, the downhole temperature sensor (248) may be disposed on the downhole pump (210), for example the temperature sensor may be attached to the downhole pump (210). In other embodiments, the temperature sensor may be part of the downhole pump (210), while in still other embodiments the downhole temperature sensor (248) may be attached to, or part of, the closed-loop geothermal system; for example: being integrated into a downhole fiber optic cable.

The downhole temperature sensor (248) may be attached to a control system (250) by a communications channel (254). In some embodiments the control system (250) may be deployed on the surface of the earth (130) while in other embodiments the control system may be located downhole. For example, in some embodiments the control system (250) the control system (250) may be an integral part of the downhole pump (210). In some embodiments, the communications channel (254) may be a wired communication channel, such as a coaxial cable, while in other embodiments the communications channel (254) may be a optical fiber cable. In still further embodiments the communications channel (254) may be a wireless communications channel.

The communications channel (254) may be configured to transmit data, such as temperature sensor readings from the downhole temperature sensor (248) to the control system (250) and/or to transmit command signals from the control system (250) to the downhole pump (210). For example, the control system (250) may, in response to received data, automatically update or adjust operational parameters of the downhole pump, such as a desired flow rate.

In some embodiments, the control system may be communicatively connected to the primary heat utilization facility (106) via a communications channel (252). The communications channel (252) may be a wired channel, such as a coaxial cable or a fiber optic cable, or the communications channel (252) may be a wireless communications channel. The communications channel (252) may carry commands transmitted by the control system (250) to the primary heat utilization facility (106) and/or to carry data from the primary heat utilization facility (106) to the control system (250). For example, the control system (250) may transmit required operational parameters, such as flow rate or the temperature of cool working fluid being pumped downhole, to the primary heat utilization facility (106) and may in turn receive data, such as the actual flow rate or the temperature of cool working fluid being pumped downhole from the primary heat utilization facility (106). The control system (250) may transmit updates or adjustments of the operational parameters to the primary heat utilization facility (106) based upon the measured downhole temperature and the desired downhole temperature, or such as a desired downhole temperature being less than the maximum operating temperature of the downhole pump.

In other embodiments, some or all of the functions of the control system may be performed manually by personnel operating the geothermal system. For example, the temperature measured by the downhole temperature sensor (248) may be monitored manually by operating personnel, and the flow rate of either, or both, the working fluid of the working fluid being pumped downhole from the primary heat utilization facility (106) and the geothermal fluid pumped by the downhole pump (210) may be controlled manually.

In some embodiments, the first downhole portion of the wellbore may be separated from the remainder of the wellbore by a fluid impermeable packer (214) configured to hydraulically isolate the first downhole portion from the remainder of the wellbore. One purpose of the packer is to allow the pressure in the first downhole portion to be lowered without the need to extract large quantities of fluid from the wellbore (102) by lowering the surface level (218) significantly. In some embodiments, a second packer (214a) may be deployed further down the wellbore below the geothermal reservoir and/or below the fluid permeable tubing (232). This second packer (214a) may have the effect of further reducing the volume of the first downhole portion (242) of the wellbore (202) within which the fluid pressure needs to be reduced to draw geothermal fluid from the geothermal reservoir.

In some embodiments, the pump may be a downhole pump (210), such as the downhole electrical submersible pump (“ESP”), while in other embodiments the pump (not shown) may be disposed on the surface of the earth (130). For either a downhole pump or a surface pump, the pump has a fluid inlet (212) disposed in the first downhole portion (242) of the wellbore (202), configured to draw geothermal fluid into the first downhole portion (242) and thence into the pump. Drawing geothermal fluid into the first downhole portion (242) in this way maintains the temperature of the fluid surrounding the downhole end of the closed-loop geothermal at a higher temperature than would otherwise be the case.

In some embodiments, the downhole pump is connected via tubing, such as production tubing (216) through which to deliver geothermal fluid at a fluid outlet (230) to a secondary processing facility (206). In some embodiments, the secondary processing facility (206) may include an electrical generator, such as an Organic Rankine system electrical generator, to provide a secondary source of electric power. In some embodiments, the secondary processing facility (206) may include a mineral extraction system configured to extract commercially valuable minerals, such as a lithium recovery system.

Lithium recovery from a brine geothermal fluid is a straightforward but time consuming process. For example, brine pumped to the surface may be retained in a series of evaporation ponds. Over a period of months, the water slowly evaporates, and a variety of salts precipitate out, leaving a brine with an ever-increasing concentration of lithium. During the evaporation process, a slurry of hydrated lime (Ca(OH)₂) may be added to the brine to precipitate out other elements, particularly magnesium and boron (as magnesium hydroxide and calcium-boron salts). When lithium concentration of the evaporating brine reaches a certain point, the brine is pumped to a recovery facility to extract the metal, a process that usually includes the following steps:
Brine purification to remove contaminants or unwanted elements.
Chemical treatment to precipitate out desirable products and byproducts.
Filtration to remove the precipitated solids.
Treatment with soda ash (Na2CO₃) to precipitate out lithium carbonate (Li2CO₃).
Washing and drying the lithium carbonate to form the final product.

As shown in FIG. 2B, in accordance with one or more embodiments, the geothermal fluid extracted from wellbore (202) may be injected into a second wellbore (202a) and from there the geothermal fluid may percolate, as indicated by the arrows (238), into the formation. In some embodiments, production tubing (216a) may carry the injected geothermal fluid from the secondary processing facility (206) down the wellbore (202a) and through a packer (214a) prior to it percolating into the formation. In some embodiments, a portion of the injected geothermal fluid may percolate through the geothermal reservoir (104), absorbing heat and rising in temperature in the process, before being drawn back into wellbore (202), while in other embodiments the purpose of injecting fluid is simply to dispose of unwanted fluid after processing by the secondary processing facility (206) and/or to maintain the geothermal fluid pressure within the geothermal reservoir.

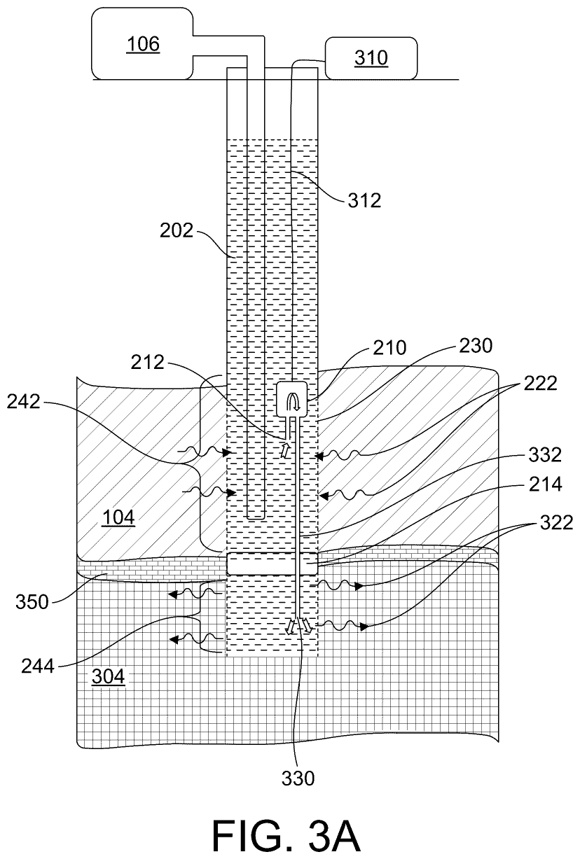

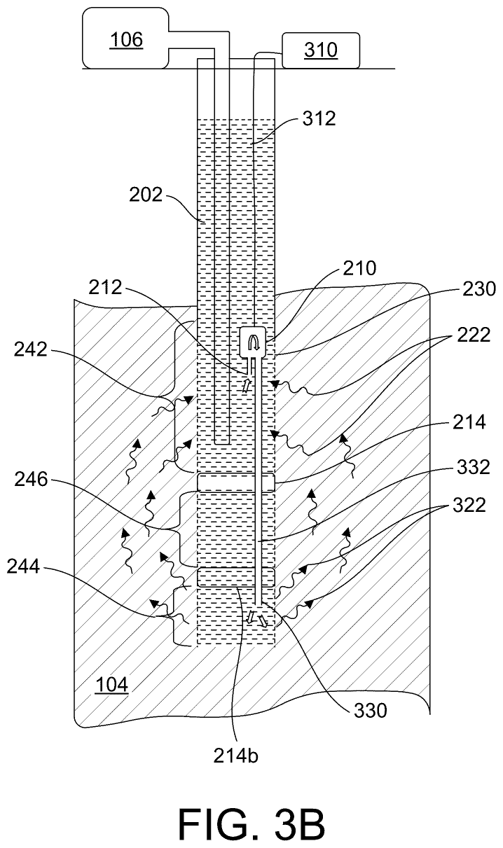

In other embodiments, the geothermal fluid may not be pumped to the surface of the earth. Instead, a packer may be placed in the well to create at least two zones with each zone inducing different subsurface flows of geothermal fluid. For example, as shown in FIG. 3A a packer, such as packer (214), may be disposed to divide the wellbore (102) into a first downhole portion (242) and a second downhole portion (244). In some embodiments, the second downhole portion (244) may lie below the first downhole portion (242), as illustrated. In some embodiments the packer may be disposed at a depth coincident with a geological layer, such as impermeable geological layer (350) that separates the geothermal reservoir (104) spatially and hydraulically from another porous, permeable layer (304) that does not form part of the geothermal reservoir (104). The presence of the packer (214), in combination with the impermeable geological layer (350), separates the spatial location at which geothermal fluid (222) is drawn from the geothermal reservoir (104) and the spatial location at which geothermal fluid (322) is pumped into the porous, permeable layer (304). Physically isolating these locations may prevent the cool geothermal fluid from looping back (or forming a “short-circuit”) to be pulled back into the first downhole portion (242) without carrying significant quantities of heat.

Both the first downhole portion and the second downhole portion may be completed, at least in part, with a fluid permeable tube, such as a slotted liner or perforated casing. As in the embodiment illustrated in FIG. 2A, the pump has an inlet configured to draw fluid from the first downhole portion (242) of the wellbore (202). However, in contrast to the embodiment illustrated in FIG. 2A, in this embodiment the outlet (330) of the pump (210), is configured to pump fluid into the second downhole portion (244) of the wellbore by means of production tubing (332), and thence into the porous, permeable layer (304). In the embodiment depicted in FIG. 3A the pump (210) may be powered by electricity supplied via a wireline (312) from an electrical power supply (310) disposed on the surface of the earth (130).

Although FIG. 3A shows only a single packer (214) disposed to separate the wellbore (102) into two portions, it will be readily apparent to a person of ordinary skill in the art that two or more packers may be deployed in the wellbore (102) to divide the wellbore (102) into three or more portions, and that one or more downhole pumps may be deployed to pump geothermal fluid from one or more of these portions into one or more other portions, for the purpose of ensuring that hot geothermal fluid is continuously supplied to the first downhole portion (242) of the wellbore (202) containing the downhole end of the closed-loop geothermal system (100) from the surrounding geothermal reservoir (104), without departing from the scope of the invention.

For example, as illustrated in FIG. 3B, in some embodiments two packers, such as packer (214) and packer (214b) may be positioned in the wellbore (102) such that both packers are located within the geothermal reservoir (104) while creating a third downhole portion (246) spatially separating the first downhole portion (242) and the second downhole portion (244). Geothermal fluid may be drawn into the fluid inlet (212) of the downhole pump (210) in the first downhole portion (242) of the wellbore (102) and then pumped through a production tubing (332) that penetrates both packer (214) and packer (214b) where the geothermal fluid discharges into the second downhole portion (244) and from thence percolates into the geothermal reservoir (104). The geothermal fluid may then percolate from the volume of the geothermal reservoir surrounding downhole portion (244), acquiring heat and rising in temperature as it percolates, before being drawn back into the first downhole portion (242). In accordance with one or more embodiments, packer (214) and packer (214b) may be separated by a distance to ensure that cool geothermal fluid percolating back from the second downhole portion (244) to the first downhole portion (242) must flow through sufficient volume of the geothermal reservoir to absorb enough heat to raise the temperature of the percolating geothermal fluid to close to the maximum operating temperature of the downhole pump (210). Similarly, the third downhole portion (246) of the wellbore (202) may be cased with an impermeable casing to prevent the third downhole portion (246) from forming a short-circuit path for fluid percolating back from the second downhole portion (244) to the first downhole portion (242).

From a thermal perspective, the closed-loop geothermal system and the pump have opposing effects on the temperature of the geothermal fluid filling the portion of the wellbore in which they are operating. In the absence of an operating pump, the closed-loop geothermal system will extract heat and lower the temperature of the fluid. In the absence of a supply of heat that is at least equal to the rate of extraction, from the surrounding geothermal reservoir, the temperature of the geothermal fluid surrounding the closed-loop geothermal system in the wellbore will ultimately fall to the temperature of the cool working fluid being supplied to the downhole end of the closed-loop geothermal system. The rate at which the temperature of the geothermal fluid surrounding the closed-loop geothermal system in the wellbore will fall depends on the design and the operating parameters of the closed-loop geothermal system. For example, the diameter of the downhole heat exchanger, if any, at the downhole end of the closed-loop geothermal system may affect the rate at which heat is extracted from the surround geothermal fluid and the rate at which temperature will fall. Similarly, the flow rate and temperature at which working fluid is provided (pumped) from the surface to the downhole end of the closed-loop geothermal system will affect the rate at which heat is extracted from the surround geothermal fluid and the rate at which temperature falls.

Several design and operating parameters influence the effectiveness of heat extraction and the controlled reduction of reservoir temperature that is required to extract heat from the closed-loop geothermal system and optimize the use of ESP, including but not limited to:
1. Working Fluid Flow Rate: Increasing the flow rate of the working fluid within the closed-loop system leads to a decrease in reservoir temperature or extract more heat. This increase of heat extraction is shown as per the relation Q=mCₚΔT where m is mass flow rate, Cₚ is the specific heat capacity and ΔT is the difference between output and inlet temperature of the closed loop system.
2. Inlet Temperature: Lowering the inlet temperature of the working fluid increases the ΔT across the heat exchanger interface, since heat extracted from the reservoir is equal to heat produced from the closed loop system and delta temperature is proportional to the last one (reducing inlet temperature would make the delta temperature value higher). Thereby improving thermal performance and heat uptake from the reservoir.
3. Thermal Conductivity separating downgoing and upgoing fluid: In coaxial closed-loop systems, the thermal conductivity of the vacuum-insulated inner tube significantly affects the rate of conductive heat transfer. Similarly, in mono U-tube systems, the presence and quality of insulation between the downflow and upflow channels are critical.
4. Material Properties of External Tubing: The external tubing of the closed-loop heat exchanger should exhibit high thermal conductivity, minimal surface roughness (to reduce frictional losses), and suitable mechanical, chemical, and thermal resistance properties. Selection of metallurgy must account for the geothermal fluid chemistry, reservoir temperature, and expected mechanical stresses.

Conversely, an operating pump will draw hot geothermal fluid into the wellbore and, in the absence of an operating closed-loop geothermal system, the geothermal fluid surrounding the pump in the wellbore will (rapidly) approach the temperature of the geothermal reservoir itself. Geothermal reservoirs may typically lie in the temperature range 150-350 deg. C (300-650 deg. F), while the maximum operating temperature of a downhole pump may only be between 190 to 250 deg. C (370 to 480 deg. F). Consequently, a downhole pump operating without some means of cooling the geothermal fluid may soon find that its environment exceeds its maximum operating temperature. This maximum operating temperature constraint may become more severe with increasing depth for at least the reason that the internal heat generated within the downhole pump in pumping fluid at a given rate increases with the depth, or equivalently hydraulic-head. This internally generated heat must be cooled by the surrounding fluid which accordingly must be cooler if a greater flux of heat must be generated.

The temperature changing effects of the closed-loop geothermal system and the downhole pump may be balanced to ensure that the maximum amount heat is extracted by the closed-loop geothermal system without violating the constraint that the maximum operating temperature of the pump is not exceeded. For example, suppose the maximum operating temperature of the pump is 250 deg. C (480 deg. F) (and assuming the maximum operating temperature of the closed-loop geothermal system is greater than 250 deg. C (480 deg. F)), while the geothermal reservoir temperature is 290 deg. C (550 deg. F). Then the closed-loop geothermal system must be operated, by controlling the temperature and flow rate of the cool working fluid supplied from the uphole end of the fluid conduit, to reduce the temperature of the geothermal fluid in the wellbore to less than 250 deg. C (480 deg. F). However, once the temperature of the geothermal fluid in the wellbore falls below 250 deg. C (480 deg. F), then the operation of the downhole pump may be initiated to begin drawing hot geothermal fluid from the reservoir, thereby ceasing a further reduction in temperature.

The lowering of downhole temperature process in the near reservoir vicinity is an almost immediate effect upon commencement of the operation of the closed-loop geothermal system. Similar to what occurs in a surface heat exchanger, there is an interface, length of equilibrium and area of contact, but the temperature of equilibrium is stable and reach equilibrium very quickly for convective systems using an electric submersible pump (ESPs). The geometry of the system, including area of contact, needs to be designed based on reservoir characteristics and potential of the hot geothermal fluid feedzones. That geometry design would prevent the maximum temperature of the flowing brine in the reservoir be reduced to at least the minimum temperature of ESP for optimal and safety operations. In conventional geothermal heat extraction systems, including those utilizing ESPs, the methodology for enhancing fluid production is primarily based on regulating the outlet pressure, thereby increasing the pressure differential (AP) across the system. This pressure differential facilitates mass transfer and enhances fluid circulation. However, ESPs are subject to operational temperature limitations, which constrain their application in high-temperature geothermal reservoirs.

In contrast, closed-loop geothermal systems aim to maximize heat extraction efficiency by regulating the outlet temperature, thereby enhancing the temperature differential (ΔT) between the injected and extracted working fluid. This ΔT is directly correlates with the system's heat transfer performance. Nevertheless, for closed-loop systems to achieve optimal convective heat exchange with the formation, the inflow of heat to the working fluid—governed by pressure drawdown mechanisms—must be enhanced. The integration of ESP technology into closed-loop configurations can improve this inflow by inducing a pressure gradient, thereby enabling the synergistic operation of both technologies.

This synergistic approach allows the pressure-driven flow benefits of conventional systems (via ESPs) to complement the temperature-driven heat extraction advantages of closed-loop systems, resulting in enhanced overall geothermal system efficiency.

In general, more than one combination of closed-loop geothermal system operating parameters and downhole pump operating parameters may satisfy the requirement of stabilizing the temperature of the geothermal fluid within the wellbore at, or just below, the maximum operating temperature of the downhole pump. Further each combination may result in a different rate of heat extraction from the geothermal reservoir to the surface. In such a situation, the combination of closed-loop geothermal system parameters and downhole pump parameters that maximize heat extraction while still producing a stable temperature of the geothermal fluid within the wellbore may be selected. Accordingly, the closed-loop geothermal system and the downhole ESP are configured to maintain the temperature of the geothermal fluid surrounding the downhole pump, such as the downhole ESP, at or below maximum operating temperature of the downhole ESP.

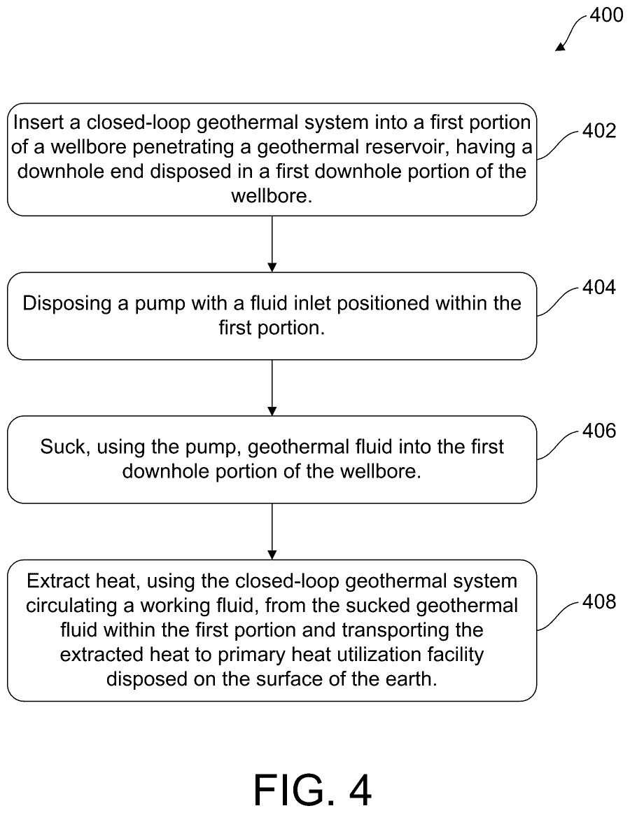

FIG. 4 shows a flowchart (400) for a workflow in accordance with embodiments. The flowchart (400) begins with Step (402) where a closed-loop geothermal system may be inserted into a wellbore penetrating a geothermal reservoir. The closed-loop geothermal system includes a bidirectional fluid conduit that is disposed in a first downhole portion of the wellbore.

In Step (404) a pump may be disposed with a fluid inlet to the pump positioned within the first downhole portion of the wellbore. In some embodiments the pump may be a downhole electrical submersible pump, while in other embodiments the pump may be located at the surface and the fluid inlet of the pump formed by tubing, such as production tubing, extending from the pump of the surface and extending to the first downhole portion of the wellbore.

In Step (406) geothermal fluid may be drawn, using the pump, into the first downhole portion of the wellbore from the geothermal reservoir surrounding the first downhole portion. In some embodiments, the geothermal fluid drawn from the geothermal may be pumped to a secondary processing facility disposed on the surface of the earth. In some embodiments, the secondary processing facility may include a mineral extraction system and or an electricity generating system, such as an Organic Rankine system. For example, the mineral extraction system may extract lithium and/or beryllium salts from the geothermal fluid.

In some embodiments, sucking the geothermal fluid into the first downhole portion of the wellbore from the geothermal reservoir surrounding the first downhole portion may include sucking the geothermal fluid through a fluid permeable tubing (232) enclosing the downhole end of the closed-loop geothermal system and a fluid inlet of the pump. In some embodiments, the fluid permeable tubing (232) may be a slotted liner, while in other embodiments the fluid permeable tubing (232) may be a sand-screen or a perforated casing.

In Step (408) heat may be extracted from the geothermal fluid drawn into the first downhole portion using a closed-loop geothermal system containing a circulating working fluid. The circulating working fluid may absorb heat, in some embodiments with the aid of a downhole heat exchanger and transported in the working fluid to a primary heat utilization facility disposed on the surface of the earth. The primary heat utilization facility may include an electrical generation system. In addition, the heat utilization facility may provide heat directly for use in onsite for chemical processing or industrial activities, or for the heating of commercial, industrial, and residential buildings.

In some embodiments, at least one packer, may be deployed downhole to fluidically separate the first downhole portion from a second downhole portion of the wellbore. In some embodiments, the purpose of the packer may be to separate the first downhole portion from the remainder of the wellbore to facilitate the lowering of fluid pressure within the first downhole portion and to increase the effectiveness of sucking geothermal fluid into the first downhole portion. In other embodiments, the installation of at least one packer may be to create a second downhole portion of the wellbore into which to pump geothermal fluid from the first downhole portion. The inventive method may include pumping, using the pump, the geothermal fluid drawn into the first downhole portion into the second downhole portion, wherein the pumped fluid in the second downhole portion may percolate into a rock formation surrounding the second downhole portion. Thus, the one or more hydraulically impermeable packers may be used to for a first downhole portion into which geothermal fluid may be drawn to provide heat for the closed-loop geothermal system, and a second downhole portion into which the geothermal fluid may be pumped by the pump, after giving up its heat to the closed-loop geothermal fluid, where is may seep or percolate from the second downhole portion of the wellbore back into another, fluidly isolated portion or layer of the subterranean region.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A geothermal system, comprising:
a wellbore penetrating a geothermal reservoir;
a closed-loop geothermal system disposed in the wellbore, having a downhole end disposed in a first downhole portion of the wellbore,
wherein the closed-loop geothermal system comprises a fluid conduit, and
wherein the first downhole portion lies within the geothermal reservoir;
a primary heat utilization facility disposed on the surface of the earth and connected to an uphole end of the fluid conduit; and
a pump configured to draw geothermal fluid into the first downhole portion of the wellbore.

2. The geothermal system of claim 1, wherein the pump is further configured to pump the drawn geothermal fluid to a secondary processing facility disposed on the surface of the earth.

3. The geothermal system of claim 2, wherein the secondary processing facility comprises a mineral extraction system.

4. The geothermal system of claim 1, wherein the pump is a downhole electrical submersible pump (“ESP”).

5. The geothermal system of claim 4, further comprising a control system configured to maintain a temperature of the geothermal fluid surrounding the downhole ESP below a maximum operating temperature of the downhole ESP, by monitoring the temperature of the geothermal fluid surrounding the downhole ESP and adjusting an operating parameter of the closed-loop geothermal system and the downhole ESP.

6. The geothermal system of claim 1, further comprising at least one packer fluidically separating the first downhole portion from a second downhole portion.

7. The geothermal system of claim 6, wherein the pump is further configured to pump the geothermal fluid drawn into the first downhole portion into the second downhole portion, wherein the geothermal fluid pumped into the second downhole portion percolates into a rock formation surrounding the second downhole portion.

8. The geothermal system of claim 1, further comprising a fluid permeable tubing enclosing the downhole end of the closed-loop geothermal system and a fluid inlet of the pump.

9. The geothermal system of claim 8, wherein the fluid permeable tubing comprises a slotted liner.

10. The geothermal system of claim 8, wherein the primary heat utilization facility comprises an electrical generator.

11. A method for extracting geothermal energy, comprising:
inserting a closed-loop geothermal system into a wellbore penetrating a geothermal reservoir,
wherein the closed-loop geothermal system comprises a fluid conduit, and
wherein a downhole end of the fluid conduit is disposed in a first downhole portion of the wellbore;
disposing a pump with a fluid inlet positioned within the first downhole portion;
drawing, using the pump, geothermal fluid into the first downhole portion of the wellbore; and
extracting heat, using the closed-loop geothermal system circulating a working fluid, from the drawn geothermal fluid within the first downhole portion and transporting the extracted heat to a primary heat utilization facility disposed on the surface of the earth.

12. The method of claim 11, further comprising pumping the drawn geothermal fluid to a secondary processing facility disposed on the surface of the earth.

13. The method of claim 12, further comprising extracting, using a mineral extraction system within the secondary processing facility, lithium from the drawn geothermal fluid.

14. The method of claim 12, further comprising extracting, using an Organic Rankine system within the secondary processing facility, heat from the drawn geothermal fluid.

15. The method of claim 11, further comprising disposing at least one packer within the wellbore to fluidically separate the first downhole portion from a second downhole portion.

16. The method of claim 16, further comprising pumping, using the pump, the geothermal fluid drawn into the first downhole portion into the second downhole portion, wherein the pumped fluid in the second downhole portion percolates into a rock formation surrounding the second downhole portion.

17. The method of claim 11, wherein sdrawing geothermal fluid into the first downhole portion further comprises drawing the geothermal fluid through a fluid permeable tubing enclosing the downhole end of the closed-loop geothermal system and a fluid inlet of the pump.

18. A method of extracting geothermal energy, comprising:
inserting a closed-loop geothermal system into a first portion of a wellbore penetrating a geothermal reservoir;
extracting, by operating the closed-loop geothermal system, heat from the geothermal reservoir,
wherein extracting heat lowers a temperature of geothermal fluid filling the first portion of the wellbore;
inserting a downhole pump into the first portion of the wellbore once the temperature of the geothermal fluid within the first portion has cooled below a maximum operating temperature of the downhole pump; and
operating the downhole pump at a first rate to extract cooled geothermal fluid from the first portion and draw hot geothermal fluid into the first portion from the geothermal reservoir,
wherein the drawn hot geothermal fluid increases the temperature of the geothermal fluid within the first portion.

19. The method of claim 18, further comprising:
monitoring the temperature of the geothermal fluid within the first portion; and
adjusting the operation of the downhole pump to a second rate to stabilize the temperature of the geothermal fluid within the first portion at or below the maximum operating temperature of the downhole pump.

20. The method of claim 19, wherein monitoring the temperature comprises transmitting a measured temperature from a temperature sensor to a control system and adjusting the operation of the downhole pump comprises transmitting a command signal from the control system to the downhole pump.
